(19) United States
(12) Patent Application Publication
(10) Pub. No.: US 2013/0063336 A1
(43) Pub. Date: Mar. 14, 2013

(54) VEHICLE USER INTERFACE SYSTEM

(71) Applicants: Naoki Sugimoto, Sunnyvale, CA (US); Fuminobu Kurosawa, Cupertino, CA (US); Tatsuya Kyomitsu, Cupertino, CA (US)

(72) Inventors: Naoki Sugimoto, Sunnyvale, CA (US); Fuminobu Kurosawa, Cupertino, CA (US); Tatsuya Kyomitsu, Cupertino, CA (US)

(73) Assignee: HONDA MOTOR CO., LTD., Tokyo (JP)

(21) Appl. No.: 13/228,395

(22) Filed: Sep. 8, 2011

(51) Int. Cl. G09G 5/00

(52) U.S. Cl. 345/156

(57) ABSTRACT

A driver can point at a vehicle display using a hand on the steering wheel. The vehicle display may be located in the dashboard behind the steering wheel. The location on the display at which the driver is pointing is determined using sensors, and a cursor is displayed at this location. Finger movement is detected by the sensors and a user interface function is performed in response. The performed user interface functions may include the movement of the displayed cursor on the vehicle display, the display of additional vehicle information, the launching of an application, the interaction with an application, and the scrolling of displayed information.

### FIELD OF THE INVENTION

The exemplary embodiments relate to the field of vehicle user interface systems, and in particular to a vehicle user interface system which can be navigated using finger gestures.

### BACKGROUND OF THE INVENTION

Vehicle technologies and features available to and controlled by a driver have advanced in recent years. Example of these features include in-vehicle maps and navigation, phone calls, video and audio media players, satellite radio, and vehicle computer system interfaces. Many of these features require a display or monitor to display information related to these features. Thus, there is a benefit to implementing these features in a way that allows a driver to keep both hands on the wheel and that minimizes the line of sight divergence from the driver's field of vision.

### SUMMARY OF THE INVENTION

A vehicle user interface system which allows a user to interact with the system using a finger on a hand which is gripping the steering wheel is described. An activation gesture is optionally identified from the user hand on the steering wheel. Sensors may identify the activation gesture, and the gesture may be performed with a single finger. A location on a vehicle display at which a user is pointing is determined. The display may be located behind the steering wheel in the vehicle dashboard. The location at which a user is pointing may be determined based on the position and orientation of the base and the tip of the user's finger. A cursor is displayed at the determined display location.

User pointing finger movement is detected. The pointing finger may move to point at a new display location. In response to such a detected finger movement, the displayed cursor is moved to the new display location. The pointing finger may instead perform a finger gesture. An interface function is performed in response to the detected finger gesture. For example, displayed information may be scrolled, information may be selected, applications may be selected and launched, or any of the other interface operations discussed herein may be performed.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1a illustrates a vehicle user interface system navigable by finger gestures in accordance with one embodiment.

FIG. 1b illustrates an example graphical user interface displayed on a vehicle display in accordance with one embodiment.

FIG. 2a illustrates a vehicle environment for a vehicle user interface system navigable by finger gestures in accordance with one embodiment.

FIG. 2b illustrates a user interface module for allowing a user to interact with the vehicle user interface system using finger gestures in accordance with one embodiment.

FIG. 3 is a flowchart illustrating the process of interacting with the vehicle user interface system in accordance with one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Vehicle User Interface System Overview

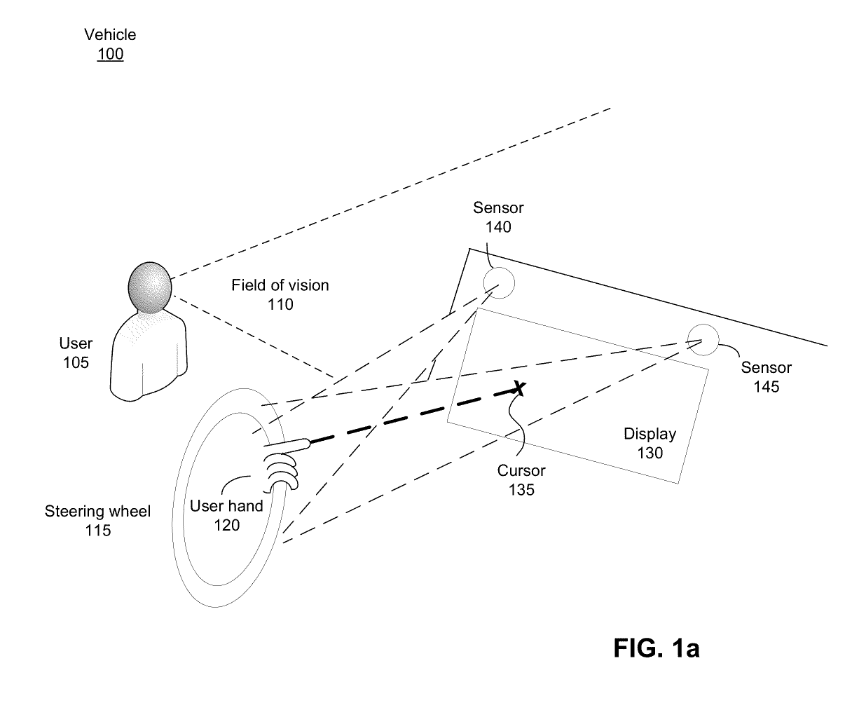

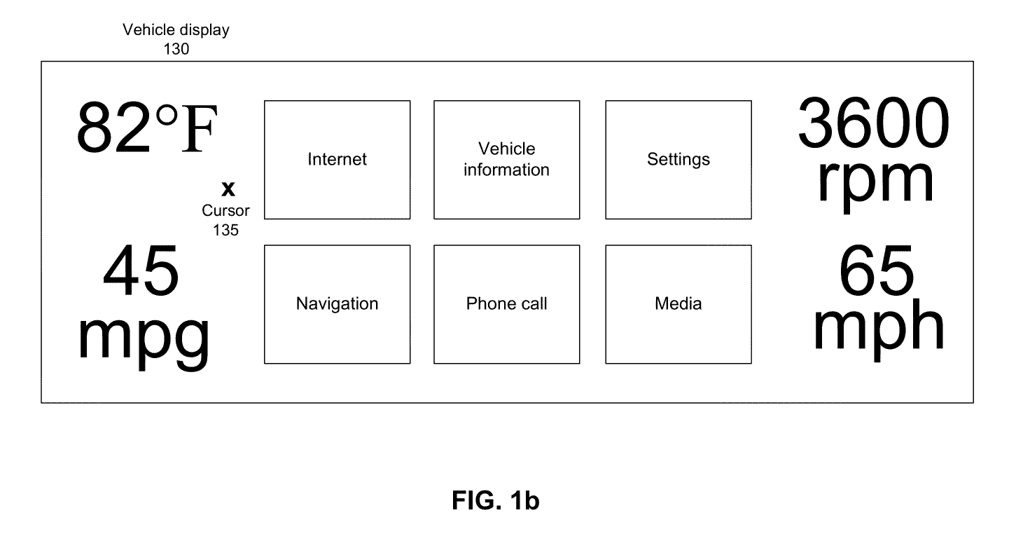

FIG. 1a illustrates a vehicle user interface system navigable by finger gestures in accordance with one embodiment. The vehicle user interface system described herein is implemented in a vehicle 100 and provides seamless access to information. The vehicle 100 may be a passenger automobile, a utility vehicle, a semi-truck, a motorcycle, a tractor, a bus or van, an ambulance or fire truck, a personal mobility vehicle, a scooter, a drivable cart, an off-road vehicle, a snowmobile, or any other type of vehicle capable of driving roads, paths, trails, or the like.

The user 105 is the driver of the vehicle 100, and accordingly the user's hand 120 is on the steering wheel 115. As used herein, the user's hand 120 is considered to be on the steering wheel 115 when the user 105 is holding the steering wheel 115 or gripping the steering wheel 115, or any time the user's hand 140 is in contact with the steering wheel 115. Although not illustrated, both of the user's hands may be on the steering wheel 115. In addition, although the user's right hand 120 is displayed in the embodiment of FIG. 1a, the user 105 may instead navigate the vehicle user interface system with the user's left hand. The user 105 may point at the display 130 or may perform one or more finger gestures with one or more fingers without removing the user's hand 120 from the steering wheel 115. In one embodiment, finger gestures are performed with a single finger. As used herein, the pointing finger means the finger being used to point at the display 130 and may include any of the fingers or the thumb on the user's hand 120. In alternative embodiments, finger gestures are performed with multiple fingers, and may be performed by one or more fingers on each hand.

The vehicle 100 includes a display 130 which displays a graphical user interface (GUI) explained in greater detail in FIG. 1b. The display 130 comprises any type of display capable of displaying information to the user 105, such as a monitor, a screen, a console, or the like. The display 130 displays a cursor 135 in response to a determination of the location on the display 130 at which the user 105 is pointing with the user's hand 120. The cursor 135 may be displayed in any format, for instance as an arrow, an “X”, a spot or small circle, or any other suitable format for indicating to the user 105 the location on the display 130 at which the user 105 is pointing. Alternatively, instead of displaying a cursor 135, the display 130 may highlight the icon or information closest to the location at which the user 105 is pointing.

The user 105 has a field of vision 110 when looking out the front windshield at the road directly in front of the vehicle 100, on which the vehicle 100 is driving. In the embodiment of FIG. 1a, the display 130 is located in the dashboard behind the steering wheel 115, and is configured so that the display 130 is facing the user 105. In this embodiment, the display 130 is within the field of vision 110 of the user 105, minimizing the distance the user's eyes must shift in order to go from looking at the road to looking at the display 130. In one example embodiment, the display 130 is located between 6″ and 24″ behind the steering wheel. In another example embodiment, the display 130 is located within 15° below the user's 105 natural line of sight when the user 105 is driving the vehicle 100 and looking out the windshield at the road in directly front of the vehicle 100.

In one embodiment, instead of directly facing the user 105, the display 130 is located in the dashboard of the vehicle 100 such that the display 130 projects onto the windshield or onto a mirror mounted on the dashboard or the windshield such that the projected display is reflected to the user 105. In such an embodiment, the display 130 displays a GUI and other information in reverse, such that when the projected display is reflected to the user 105, the GUI and other information are properly oriented for viewing by the user 105. In this embodiment, the display 130 is viewable by the user 105 in a location which requires even less eye displacement by the user 105 when the user 105 is viewing the road than the embodiment of FIG. 1a. Alternatively, the display 130 may be located elsewhere within the vehicle 100, such as in the center console, or in a drop-down display from the ceiling of the vehicle 100.

The vehicle 100 includes one or more sensors to identify the location on the display 130 at which the user 105 is pointing, and to identify subsequent locations on the display 130 at which the user 105 is pointing when the user 105 moves the pointing finger to point at a new location on the display. In addition, the one or more sensors may identify particular finger gestures the user 105 may perform. Both identifying locations on the display 130 at which the user is pointing and finger gestures are referred to herein collectively as “finger tracking”. In the embodiment of FIG. 1a, the vehicle 100 includes the sensors 140 and 145. Using two sensors may allow the vehicle user interface system to better estimate depth and determine the location on the display 130 at which the user is pointing. Alternatively, in other embodiments, only one sensor is used, or three or more sensors are used, with the same or differing levels of accuracy.

In one embodiment, instead of determining the location on the display 130 at which the user 105 is pointing, the one or more sensors determine that the user is pointing and determine the movement of the user's finger relative to the initial pointing position. In such an embodiment, a cursor 135 may be displayed at a default location on the display 130, and may be moved based on the determined movement of the user's finger. In this embodiment, the user 105 is not required to point at the display 130 in order to navigate the display GUI as the displayed cursor location is independent of the initial location at which the user is pointing, and instead is dependent only on the movement of the user's pointing finger relative to the initial location at which the user is pointing.

The one or more sensors used by the vehicle 100 for finger tracking may be standard cameras. In one particular embodiment, two cameras are arranged in a stereo camera configuration, such that 3D images may be taken of a user's finger in order to determine the exact angle and orientation of the user's finger. Alternatively, an infrared camera may be used by the vehicle 100 for finger tracking. In this embodiment, a single infrared camera may determine the depth and orientation of the user's finger. In alternative embodiments, the sensors used by the vehicle 100 for finger tracking may include capacitance sensors (similar to those implemented within the Theremin musical instrument), ultra-sound detection, echo-location, high-frequency radio waves (such as mm or μm waves), or any other sensor technology capable of determining the position, orientation, and movement of a finger.

The one or more sensors used by the vehicle 100 may be located in a variety of locations. For instance, the one or more sensors may be located in the dashboard of the vehicle 100 above, below, or to the sides of the display 130. Alternatively, the one or more sensors may be located within or behind the display 130. The one or more sensors may be located in the steering wheel or the steering column, in the center console of the vehicle 100, in the sides or doors of the vehicle 100, affixed to the front windshield or the other windows of the vehicle 100, in the ceiling of the vehicle 100, in the rearview mirror, or in any other vehicle component. The one or more sensors may be located in front of or behind the user 105, to the sides of the user 105, above or below the user's hand 120, or in any other configuration suitable for detecting finger position, orientation or movement.

In one embodiment, the user interface system of the vehicle 100 is capable of being interacted with by the user 105 only when the steering wheel 115 is in a neutral position. For example, if the user 105 turns the steering wheel 115 while driving, the user interface system may assume that the user's attention is required for driving around a turn, switching lanes, avoiding objects in the road, and the like, and the user interface system may lock the user interface system and may prevent the user 105 from interacting with the user interface system. The amount the steering wheel 115 needs to be rotationally displaced in order to cause the user interface system to lock may be pre-determined.

FIG. 1b illustrates an example GUI displayed on a vehicle display 130 in accordance with one embodiment. It should be noted that the type and configuration of information displayed in the embodiment of FIG. 1b is selected for the purposes of illustration only, and is not intended in any way to be restrictive or limiting.

The display 130 in the embodiment of FIG. 1b displays internal and external vehicle information. For example, the display 130 displays the temperature outside the vehicle (82° F.), the fuel efficiency of the vehicle (45 miles per gallon), the speed of the engine (360° rotations per minute), and the speed of the vehicle (65 miles per hour). The display 130 in the embodiment of FIG. 1b also displays various icons for selection by the user 105. For example, the display 130 displays an internet icon, a vehicle information icon, a settings icon, a navigation icon, a phone call icon, and a media icon. Additional internal and external vehicle information and other types of information may be displayed, and different/additional/fewer or no icons may be displayed.

The display 130 also displays the cursor 135, indicating the location on the display 130 at which the user 105 is pointing. As discussed above, the display 130 moves the cursor 135 around the display 130 to track the movement of the user's finger. In addition to moving the cursor, the user may perform a variety of finger gestures in order to interact with display information and icons. For instance, using finger gestures, the user may be able to scroll through information or icons, select information or icons, launch an application through the selection of an icon, change the information or icons displayed, change vehicle settings, play media, make a call, access remote information, or any of a variety of other vehicle user interface system functions.

In one embodiment, the information displayed by the display 130 is pre-set by the user 105 or the manufacturer of the vehicle 100. The user 105 may configure the displayed information using the vehicle user interface system. In one embodiment, the display 130 gives priority to urgent information, and displays the urgent information in place of the pre-determined displayed information by either shutting down or minimizing the GUI. For example, if tire pressure is low, gas is low, or an obstruction is detected in front of the vehicle, warnings indicating these circumstances may be displayed on the display 130. Similarly, if an application is running and is displayed on the display 130, the user interface system may shut down the application to display urgent information. In such an embodiment, the GUI may be

### Vehicle User Interface System Operation

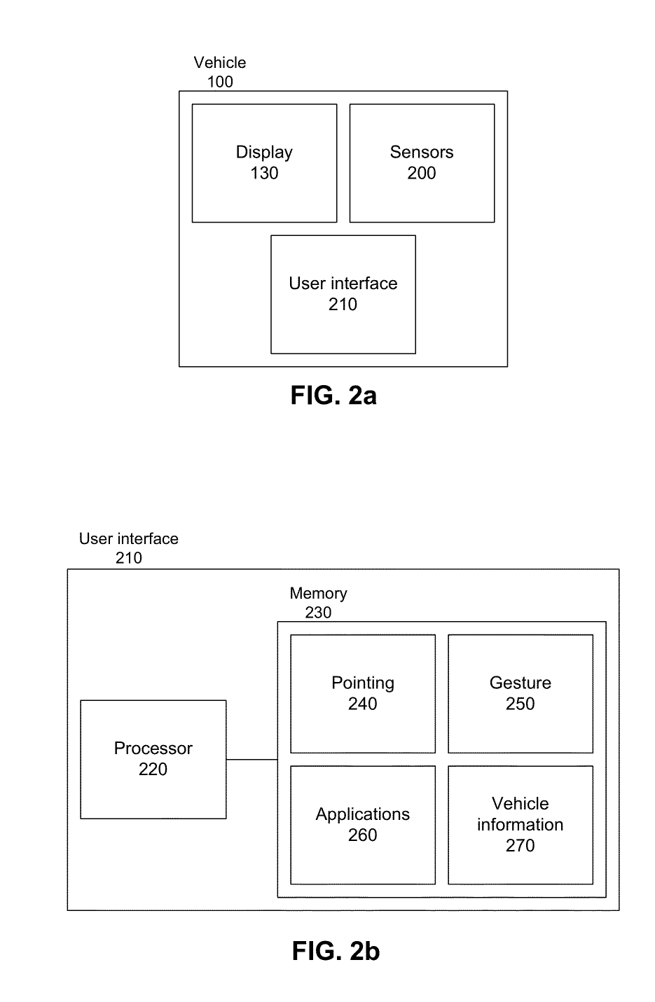

FIG. 2a illustrates a vehicle environment for a vehicle user interface system navigable by finger gestures in accordance with one embodiment. The vehicle 100 includes a display 130, sensors 200, and a user interface module 210. Note that in other embodiments, the vehicle 100 may include additional features related to the vehicle user interface system other than those illustrated in FIG. 2a.

As discussed above, the display 130 includes any component capable of displaying information to a user 105, for example a monitor or screen. Similarly, the sensors 200 include any components capable of determining the position, orientation and movement of a finger, for example traditional cameras or infrared cameras. The user interface module 210 determines the type and configuration of information to display to the user 105 through the display 130, determines the position, orientation and movement of a user's finger relative to the display 130, and allows the user to interact with the vehicle user interface system by adjusting the information displayed to the user in response to user finger movement and gestures.

FIG. 2b illustrates a user interface module 210 for allowing a user to interact with the vehicle user interface system using finger gestures in accordance with one embodiment. The user interface module 210 includes a computer processor 220 and a memory 230. Note that in other embodiments, the user interface module 210 may include additional features or components other than those illustrated in FIG. 2b. The user interface module 210 allows a user to interact with the vehicle user interface system by performing one or more user interface functions based on finger movement and gestures. “User interface functions” as used herein refers to the movement of a displayed cursor based on finger movement, the selection of displayed information, the running of an application, the interaction with a running application, the scrolling of displayed information, or the performance of any other suitable user interface functionality.

The processor 220 processes data signals and may include various computing architectures including a complex instruction set computer (CISC) architecture, a reduced instruction set computer (RISC) architecture, or an architecture implementing a combination of instruction sets. Although only a single processor is shown in FIG. 2b, multiple processors may be included. The processor 220 may include an arithmetic logic unit, a microprocessor, a general purpose computer, or some other information appliance equipped to transmit, receive and process electronic data signals from the memory 230, the display 130, the sensors 200, and any other vehicle system, such as a satellite internet uplink, wireless internet transmitter/receiver, phone system, vehicle information systems, settings modules, navigation system, media player, or local data storage.

The memory 230 stores instructions and/or data that may be executed by processor 220. The instructions and/or data may comprise code (i.e., modules) for performing any and/or all of the techniques described herein. The memory 230 may be any non-transitory computer-readable storage medium such as dynamic random access memory (DRAM) device, a static random access memory (SRAM) device, Flash RAM (non-volatile storage), combinations of the above, or some other memory device known in the art.

The memory 230 includes a pointing module 240, a gesture module 250, an applications module 260 and a vehicle information module 270. Note that in other embodiments, additional or fewer modules may be used to perform the functionality described herein. The modules stored are adapted to communicate with each other and the processor 220, as well as the display 130, the sensors 200, and any other vehicle system.

The pointing module 240 receives information describing the position, orientation and movement of a user's finger from the sensors 200 and determines the location on the display 130 at which the user is pointing. When the pointing module 240 determines the location on the display 130 at which the user is pointing, the pointing module 240 displays a cursor at the determined location on the display 130. As the user 105 moves his finger to point at new locations on the display 130, the pointing module 240 determines the movement of the location on the display 130 at which the user's finger is pointing and moves the cursor displayed on the display 130 based on the determined movement of the location on the display 130 at which the user 105 is pointing.

In one embodiment, the pointing module 240 determines the location on the display 130 at which the user is pointing based on the position and orientation of the user's finger relative to the display 130. In the embodiment, the pointing module 240 may determine the geometric plane in which the display 130 exists (for instance, by theoretically extending the edges of the display 130 into a display plane), may determine a line through the user's pointing finger (a finger line), and may determine the intersection of the finger line and the display plane to be the location on the display 130 at which the user is pointing. It should be noted that in some circumstances, the user 105 may be pointing to a location external the actual boundaries of the display 130. In such circumstances, the pointing module 240 may not display a cursor on the display 130; alternatively, the pointing module 240 may display a cursor on the display 130 at the location on the display 130 closest to the location on the display plane at which the user 105 is pointing.

The pointing module 240 may determine the line through the user's pointing finger in a number of ways. In one embodiment, the sensors 200 provide the 3D position and orientation of particular finger segments. For example, the sensors 200 may provide the position and orientation of the fingertip segment, the middle finger segment, and the base finger segment. In these embodiments, a line through any particular finger segment may be determined, or a line may be determined based on each finger segment (for instance by averaging the lines through all of the segments). In one embodiment, the sensors 200 provide the 3D position of the fingertip and the base of the finger, and a line is determined based on the vector from the base of the finger to the fingertip.

The gesture module 250 receives information describing the position, orientation and movement of a user's finger from the sensors 200 and identifies a finger gesture based on the received information. The gesture module 250 may be able to identify any number of pre-defined finger gestures. In addition, the user 105 may be able to add to, remove or modify the pre-defined finger gestures which the gesture module 250 can identify. The gesture module 250 may perform one or more user interface functionalities based on identified finger gestures. The pre-defined gestures may beneficially be similar to finger gestures performed on mobile phones to increase a user's familiarity with the vehicle user interface system and to decrease the learning curve for using the vehicle user interface system.

In one embodiment, a user 105 may activate the user interface 210 using an activation finger gesture. In this embodiment, the gesture module 250 identifies the activation gesture and activates the user interface 210. In one embodiment, activating the user interface 210 includes displaying a cursor on the display 130 at the location at which the user 105 is pointing, and otherwise allowing the user 105 to interact with the vehicle user interface system. Prior the receiving an activation gesture from the user 105, the user interface 210 may be inactive, and the user 105 may be prevented from interacting with the user interface 210. In one embodiment, when a user 105 raises a finger from the hand on the steering wheel to point at the display 130, the gesture module 250 may identify the gesture as an activation gesture. In one embodiment, a user may deactivate the user interface using a deactivation finger gesture. A deactivation gesture may be performed by the user 105 by lowering a finger pointing at the display 130 to the steering wheel. When the gesture module 250 identifies a deactivation gesture, the gesture module 250 may deactivate the user interface 210 by removing the cursor displayed on the display 130 and preventing the user 105 from interacting with the user interface 210.

A user 105 may select information displayed on the display 130 using a selection finger gesture. The gesture module 250 may identify a selection gesture and may perform an interface function based on the selection gesture. In one embodiment, if a user 105 selects displayed vehicle information, the gesture module 250 may cause additional information related to the selected information to be displayed. In the example embodiment of FIG. 1b, if a user 105 selects “82° F.”, the gesture module 250 may cause additional temperature and weather information to be displayed, such as the internal vehicle temperature, the weather conditions (sunny, cloudy, etc.), forecasted weather conditions, vehicle air conditioning/heating information, or any other related information. Likewise, if a user 105 selects “45 mpg”, the gesture module 250 may cause other mileage or fuel efficiency information to be displayed, and so forth. In one embodiment, if a user 105 selects an icon, the gesture module 250 causes an application related to the icon to be launched, or causes a menu or other interface associated with the icon to be displayed. In the example embodiment of FIG. 1b, if a user 105 selects the “navigation” icon, the gesture module 250 may cause a navigation application may be launched. Likewise, if a user 105 selects the “settings” or “media” icons, the gesture module 250 may cause a menu interface associated with display settings or media to be displayed, respectfully.

In one embodiment, when the user 105 moves the cursor to information that can be selected, the gesture module 250 causes the information to be highlighted. In this embodiment, when information is highlighted, the information may be selected. A selection finger gesture may be performed by a user 105 when the user 105 is pointing at the information which the user wants to select by bending the pointing finger inward and subsequently extending the finger towards the display 130. In one embodiment, when a user 105 bends a pointing finger, the gesture module 250 “locks” the displayed cursor in place (by continuing to display the cursor in the same location on the display 130) until the user extends the pointing finger.

A user may scroll through information displayed on the display 130 using a scroll finger gesture. The gesture module 250 may identify a scroll gesture and may cause the information displayed to the user to be scrolled. As used herein, scrolling refers to displayed information being moved in one or more directions and optionally to new information being displayed in place of the moved information. In one embodiment, a scroll finger gesture is performed by a user 105 when the user 105 is pointing at an area of the display 130 which does not contain information which can be selected or at a dedicated scroll area of the display 130. In this embodiment, if a user 105 bends the pointing finger inward and subsequently extends the finger towards the display 130, the gesture module 250 locks the cursor in place. Once the cursor is locked in place, the user 105 may subsequently point at different locations on the display 130, and the gesture module 250 may cause the information displayed to be scrolled in the direction of the subsequent locations pointed at by the user 105. Likewise, once the cursor is locked in place, the user 105 may subsequently swipe a finger in one or more directions, and the gesture module 250 may cause the information displayed to be scrolled in the direction of the swipe.

In one embodiment, the gesture module 250 may identify multi-finger gestures. For example, if a user 105 wants to zoom in or zoom out on displayed information, the user 105 may pinch two fingers together, or may pull two fingers apart, respectfully. Likewise, if a user 105 wanted to rotate displayed information, the user 105 may rotate two fingers around each other. In one embodiment, the gesture module 250 may identify multi-finger gestures for gestures involving one or more fingers on both hands. Multi-point gestures may be performed and identified for one or more hands on the steering wheel 115.

The applications module 260 causes application icons to be displayed, receives selection information from the gesture module 250, and causes selected applications to be run in response. The applications module 260 stores applications, and may retrieve additional applications if requested to do so by the user 105. The applications module 260 provides application functionality and causes application interfaces to be displayed when the applications are selected by the user 105. In conjunction with the pointing module 240 and the gestures module 250, the applications module 260 may allow a user 105 to interact with information displayed within an application. For example, if a user 105 selects a navigation application, the applications module 260 may cause an address box to be displayed. The applications module 260 may allow a user 105 to speak an address into the address box or may allow a user 105 to select from among a list of addresses. In response to an address being selected, the applications module 260 may cause a map to be displayed.

The vehicle information module 270 causes vehicle information to be displayed, receives selection information from the gesture module 250, and causes additional or different vehicle information to be displayed. For example, a user 105 may select displayed engine speed information, and the vehicle information module 270 may display additional engine speed information. In one embodiment, the vehicle information displayed on the display 130 is pre-determined. In one embodiment, a user 105 may configure which information is displayed to the user 105. Both the vehicle information module 270 and the applications module 260 may be communicatively coupled with vehicle systems not displayed in FIG. 2b in order to retrieve vehicle information and provide application functionality, respectfully. For example, the vehicle information module 270 may be coupled to an engine speed sensor in order to provide engine speed information. Likewise, the applications module 260 may be coupled to a satellite phone in order to provide phone call functionality through a telephone application.

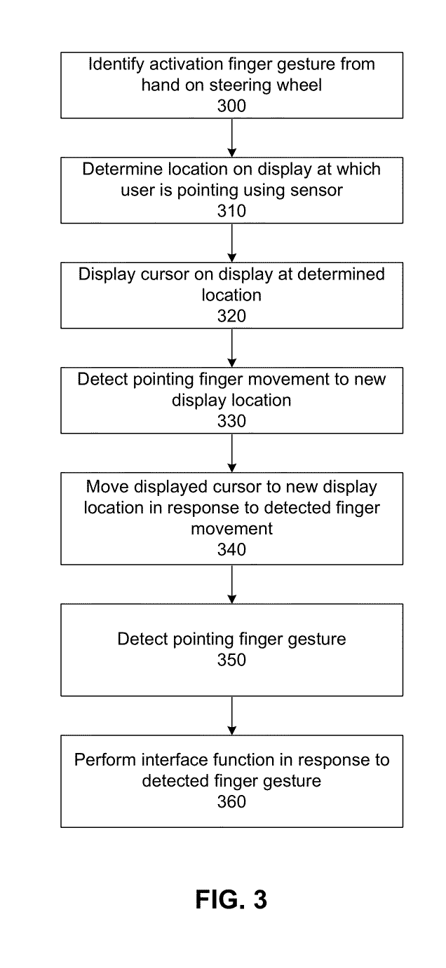

FIG. 3 is a flowchart illustrating the process of interacting with the vehicle user interface system in accordance with one embodiment. An activation gesture is optionally identified 300 from a hand of a user on a steering wheel. As discussed above, sensors may identify the activation gesture, and the gesture may be performed with a single finger. A location at which a user is pointing is determined 310 on a vehicle display. The display may be located behind the steering wheel in the vehicle dashboard. The location at which a user is pointing may be determined 310 based on the position and orientation of the base and the tip of the user's finger. A cursor is displayed 320 at the determined display location.

User pointing finger movement is detected 330, wherein the pointing finger points at a new display location. In response to the detected finger movement, the displayed cursor is moved 340 to the new display location. For example, if the user points to the left of the original location on the display at which the user was pointing, the displayed cursor is moved to left. A user pointing finger gesture may also be detected 350. An interface function is performed 360 in response to a detected finger gesture. For example, displayed information may be scrolled, information may be selected, applications may be selected and run, or any of the other interface operations discussed above may be performed.

### Additional Considerations

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions could be embodied in software, firmware or hardware, and when embodied in software, could be downloaded to reside on and be operated from different platforms used by a variety of operating systems. The embodiment can also be in a computer program product which can be executed on a computing system.

The exemplary embodiments also relate to an apparatus for performing the operations herein. This apparatus may be specially constructed for the purposes, e.g., a specific computer in a vehicle, or it may comprise a general-purpose computer selectively activated or reconfigured by a computer program stored in the computer which can be in a vehicle. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the exemplary embodiments are not described with reference to any particular programming language. It will be appreciated that a variety of programming languages may be used to implement the teachings as described herein, and any references below to specific languages are provided for disclosure of enablement and best mode.

In addition, the language used in the specification has been principally selected for readability and instructional purposes, and may not have been selected to delineate or circumscribe the inventive subject matter. Accordingly, the disclosure is intended to be illustrative, but not limiting, of the scope of the embodiments.

While particular embodiments and applications have been illustrated and described herein, it is to be understood that the embodiment is not limited to the precise construction and components disclosed herein and that various modifications, changes, and variations may be made in the arrangement, operation, and details of the methods and apparatuses without departing from the spirit and scope.

What is claimed is:

1. A method of navigating a vehicle user interface system comprising:
determining the location on a vehicle display at which a user is pointing with a pointing finger, wherein the pointing finger is part of a user's hand which is in contact with a vehicle steering wheel;
displaying a cursor on the vehicle display at the determined location;
detecting movement of the pointing finger; and
performing a user interface function in response to the detected pointing finger movement.

2. The method of claim 1, wherein one or more sensors determine the location on a vehicle display at which a user is pointing or detect movement of the pointing finger.

3. The method of claim 1, wherein determining the location on a vehicle display at which a user is pointing comprises:
determining the location of the base of the pointing finger;
determining the location of the tip of the pointing finger; and
determining the location on the vehicle display which is intersected by the line which intersects the location of the base of the pointing finger and the location of the tip of the pointing finger.

4. The method of claim 1, wherein the detected pointing finger movement comprises a change in the location on the vehicle display at which the user is pointing to a new location, and wherein the performed user interface function comprises displaying the cursor at the new location.

5. The method of claim 1, wherein the vehicle display displays at least one of vehicle information and application information.

6. The method of claim 5, wherein the detected pointing finger movement comprises a finger gesture, wherein the finger gesture comprises a selection gesture when the displayed cursor is located over displayed vehicle information, and wherein the performed user interface function comprises the display of additional information related to the selected vehicle information.

7. The method of claim 5, wherein the detected pointing finger movement comprises a finger gesture, wherein the finger gesture comprises a selection gesture when the displayed cursor is located over a displayed application icon, and wherein the performed user interface function comprises the launching of the application associated with the selected application icon.

8. The method of claim 5, wherein the detected pointing finger movement comprises a finger gesture, wherein the finger gesture comprises an interaction gesture, and wherein the performed user interface function comprises an interaction within a running application.

9. The method of claim 5, wherein the detected pointing finger movement comprises a finger gesture, wherein the finger gesture comprises a scrolling gesture, and wherein the performed user interface function comprises the scrolling of displayed information.

10. The method of claim 1, wherein the vehicle display is located in a vehicle dashboard behind the steering wheel.

11. A vehicle user interface system comprising:
a vehicle display;
one or more vehicle sensors configured to:
determine the location on the vehicle display at which a user is pointing with a pointing finger, wherein the pointing finger is part of a user's hand which is in contact with a vehicle steering wheel; and
detect movement of the pointing finger;
a cursor module configured to display a cursor on the vehicle display at the determined location; and
an interaction module configured to perform a user interface function in response to the detected pointing finger movement.

12. The system of claim 11, wherein the one or more vehicle sensors comprise one of: cameras, infrared cameras, capacitance location detectors, ultrasound location detectors, echolocation detectors, and high frequency location detectors.

13. The system of claim 11, wherein determining the location on a vehicle display at which a user is pointing comprises:
determining the location of the base of the pointing finger;
determining the location of the tip of the pointing finger; and
determining the location on the vehicle display which is intersected by the line which intersects the location of the base of the pointing finger and the location of the tip of the pointing finger.

14. The system of claim 11, wherein the detected pointing finger movement comprises a change in the location on the vehicle display at which the user is pointing to a new location, and wherein the performed user interface function comprises displaying the cursor at the new location.

15. The system of claim 11, wherein the vehicle display displays at least one of vehicle information and application information.

16. The system of claim 15, wherein the detected pointing finger movement comprises a finger gesture, wherein the finger gesture comprises a selection gesture when the displayed cursor is located over displayed vehicle information, and wherein the performed user interface function comprises the display of additional information related to the selected vehicle information.

17. The system of claim 15, wherein the detected pointing finger movement comprises a finger gesture, wherein the finger gesture comprises a selection gesture when the displayed cursor is located over a displayed application icon, and wherein the performed user interface function comprises the launching of the application associated with the selected application icon.

18. The system of claim 15, wherein the detected pointing finger movement comprises a finger gesture, wherein the finger gesture comprises an interaction gesture, and wherein the performed user interface function comprises an interaction within a running application.

19. The system of claim 15, wherein the detected pointing finger movement comprises a finger gesture, wherein the finger gesture comprises a scrolling gesture, and wherein the performed user interface function comprises the scrolling of displayed information.

20. The system of claim 11, wherein the vehicle display is located in a vehicle dashboard behind the steering wheel.
